(19) United States
(12) Patent Application Publication
(10) Pub. No.: US 2026/0212646 A1
(43) Pub. Date: Jul. 23, 2026

(54) INFORMATION PROCESSING DEVICE, INFORMATION PROCESSING METHOD, PROGRAM, AND INFORMATION PROCESSING SYSTEM

(71) Applicant: KONICA MINOLTA, INC., Tokyo (JP)

(72) Inventor: Kiichi Okuno, Yokohama-shi, Kanagawa (JP)

(73) Assignee: KONICA MINOLTA, INC., Tokyo (JP)

(21) Appl. No.: 19/140,026

(22) PCT Filed: Dec. 8, 2023
(86) PCT No.: PCT/JP2023/044118

§ 371 Date: Jun. 17, 2025

(30) Foreign Application Priority Data
Dec. 23, 2022 (JP) 2022-207135

(51) Int. Cl. G06V 10/764; G06F 16/583; G06V 10/98

(52) U.S. Cl. CPC G06V 10/764; G06F 16/583; G06V 10/98

(57) ABSTRACT

An information processing device includes a hardware processor. The hardware processor is configured to detect a plurality of target areas from one image by using a first trained model. The hardware processor is configured to output explanation information explaining a reason for detection for each of the plurality of target areas detected by the hardware processor.

### TECHNICAL FIELD

The present invention relates to an information processing device, an information processing method, a program, and an information processing system.

### BACKGROUND ART

There is a technique for acquiring an estimation result that is related to input data such as an image by inputting the input data to a pre-trained machine learning model, and presenting a basis of the acquired estimation result to a user. For example, in the technology described in Patent Literature 1, abnormality detection is performed by dividing an image into segments by a pre-set method. Explanations of respective abnormality detection results for the image segments are integrated and displayed.

### CITATION LIST

### Patent Literature

Patent Literature 1: Japanese Unexamined Patent Publication No. 2021-071808

### SUMMARY OF INVENTION

### Technical Problem

However, even with the use of the technique of prior art for presenting the basis of the detection result to the user, there arises a problem of the basis of the detection result not being correctly displayed. It has been found that such a problem occurs when there are a plurality of detection areas in an image and over-detection is included therein. Furthermore, as a result of diligent study on the cause of the problem, it has been found that, in a case where a plurality of detection areas are present in one image and over-detection is present among them, a problem arises in that an explanation (a reason or basis) of a detection result is output on an image-by-image basis by a conventional technique.

The present invention has been made in view of the above-described problem. An object of the present invention is to provide an information processing device, an information processing method, a program, and an information processing system that can correctly provide an explanation of a detection result even when there are a plurality of detection areas in an image.

### Solution to Problem

The above object of the present invention is achieved by the following means.
(1) An information processing device according to a first aspect includes a detection part and an explanation part. The detection part is configured to detect a plurality of target areas from one image by using a first trained model. The explanation part is configured to output explanation information explaining a reason for detection for each of the plurality of target areas detected by the detection part.
(2) The information processing device according to the first aspect, in which the explanation part is configured to apply a method of explainable AI to information on detection processing of the detection part to obtain the explanation information of each of the plurality of target areas.
(3) The information processing device according to the first aspect further includes a determination part that is configured to perform processing of classifying a detection target using a second trained model, and, after the processing, acquire a feature amount of the second trained model. The determination part is configured to acquire a feature amount of each target area by inputting a cut-out image of the target area to the second trained model. The explanation part is configured to apply a method of explainable AI to the feature amount of each target area acquired from the second trained model to obtain the explanation information of each of the plurality of target areas.
(4) The information processing device according to the first aspect further includes a mask processing part configured to perform mask processing on a feature map of the first trained model. The mask processing part is configured to generate a masked feature map of each of the target areas by performing mask processing using each of the target areas. The explanation part is configured to apply a method of explainable AI to the masked feature map of each of the target areas to obtain the explanation information of each of the plurality of target areas.
(5) The information processing device according to the first aspect, in which the target area is an abnormality candidate, and the explanation part is configured to output explanation information explaining a reason for detection for each of the plurality of abnormality candidates.
(6) The information processing device according to the first aspect, in which the explanation part is configured to perform the following: search for and retrieve a similar image that is similar to a detection target from among training images by using a method of similar image retrieval; and output, as the explanation information for each of the plurality of target areas, the similar image that has been retrieved or information based on the similar image.
(7) An information processing method including a detection step and an explanation step. The detection step detects a plurality of target areas from one image using a first trained model. The explanation step outputs explanation information explaining a reason for detection for each of the plurality of target areas detected in the detection step.
(8) A program causing a computer to function as a detection part and an explanation part. The detection part is configured to detect a plurality of target areas from one image using a first trained model. The explanation part is configured to output explanation information explaining a reason for detection for each of the plurality of target areas detected by the detection part.
(9) An information processing system including an imaging device, an information processing device, and a display. The imaging device is configured to capture an image of a detection target. The information processing device is configured to perform object detection processing on the image captured by the imaging device. The display is configured to display a result of detection by the information processing device. The information processing device includes a detection part, an explanation part, and an output part. The detection part is configured to detect a plurality of target areas from one image by using a first trained model. The explanation part is configured to output explanation information explaining a reason for detection for each of the plurality of target areas detected by the detection part. The output part is configured to output display screen information in which the target areas are reflected in the image and the explanation information is associated with the respective target areas.

### Advantageous Effects of Invention

According to the present invention, even in a case where there are a plurality of detection areas in an image, it is possible to correctly provide an explanation of a detection result.

### BRIEF DESCRIPTION OF DRAWINGS

FIG. 1 is a diagram illustrating an example of a configuration of a system according to a first embodiment of the present invention.

FIG. 2 is an example of a configuration of an information processing device according to the first embodiment of the present invention.

FIG. 3 is an image of processing by an object detection model.

FIG. 4 is an example of an output of an information processing device according to the first embodiment of the present invention.

FIG. 5 is an example of a configuration of an information processing device according to a second embodiment of the present invention.

FIG. 6 is an image of processing by an information processing device according to the second embodiment of the present invention.

FIG. 7 is an image of processing by an explanation part according to the second embodiment of the present invention.

FIG. 8 is an example of a configuration of an information processing device according to a third embodiment of the present invention.

FIG. 9 is an image of processing by an information processing device according to the third embodiment of the present invention.

### DESCRIPTION OF EMBODIMENTS

Hereinafter, embodiments of the present invention will be described in detail with reference to the drawings. Each of the drawings is merely schematically illustrated so that the present invention may be sufficiently understood. Therefore, the present invention is not limited to the examples illustrated in the drawings. Furthermore, in the respective drawings, common constituent elements and similar constituent elements are denoted by the same reference signs, and duplicate description thereof is omitted. Furthermore, detailed description of known functions that are not directly related to the present invention may be omitted.

### First Embodiment

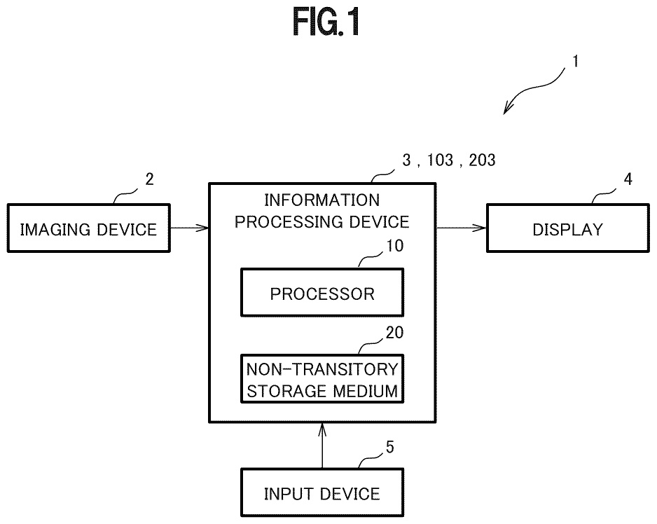

FIG. 1 is a diagram illustrating an example of a configuration of an information processing system 1 according to a first embodiment of the present invention. An information processing system 1 illustrated in FIG. 1 detects a detection target (e.g., an object or an abnormality) appearing in an image on the basis of information on the detection target learned in advance, and outputs, for each detection target, an explanation that the detection target has been detected. As will be described in detail later, the information processing system 1 is configured by combining a technique of object detection by artificial intelligence (AI) and a technique of explainable AI (XAI) (a technique of object detection by AI is, for example, an object detection technique using deep learning). XAI is a method for explaining processing that uses AI technology or a generic name for the method.

The information processing system 1 may be used in various situations without limiting a type of business. A target to be detected by the information processing system 1 includes an object (e.g., a thing or a person), an abnormality (e.g., damage, deterioration, or a disease), or the like. In the present embodiment, an object is assumed as a detection target. However, a detection target (for example, an abnormality) other than an object may be referred to.

An information processing system 1 illustrated in FIG. 1 includes an imaging device 2, an information processing device 3, a display 4, and an input device 5.

The imaging device 2 includes, for example, an image sensor. The imaging device 2 captures an image of a subject to acquire image data, and outputs the acquired image data to the information processing device 3.

The information processing device 3 is, for example, a computer including one or more processors 10 and a non-transitory storage medium 20. The information processing device 3 implements various functions related to image processing by executing, with the processor 10, a program stored in the non-transitory storage medium 20. The information processing device 3 performs object detection processing on the image data output from the imaging device 2, and outputs a detection result. In addition, by using the XAI method, the information processing device 3 outputs a reason why the detection target is detected as an explanation. The information processing device 3 creates, for example, display screen information in which the detection result of the object is reflected in the input image data and in which the reason why the detection target has been detected is associated with the detection result. Then, the information processing device 3 outputs the created display screen information to the display 4.

The display 4 is, for example, a display including a liquid crystal monitor or the like. The display 4 is capable of displaying the display screen information output from the information processing device 3.

The input device 5 is, for example, a user-operable input device such as a mouse, a keyboard, or a touch screen.

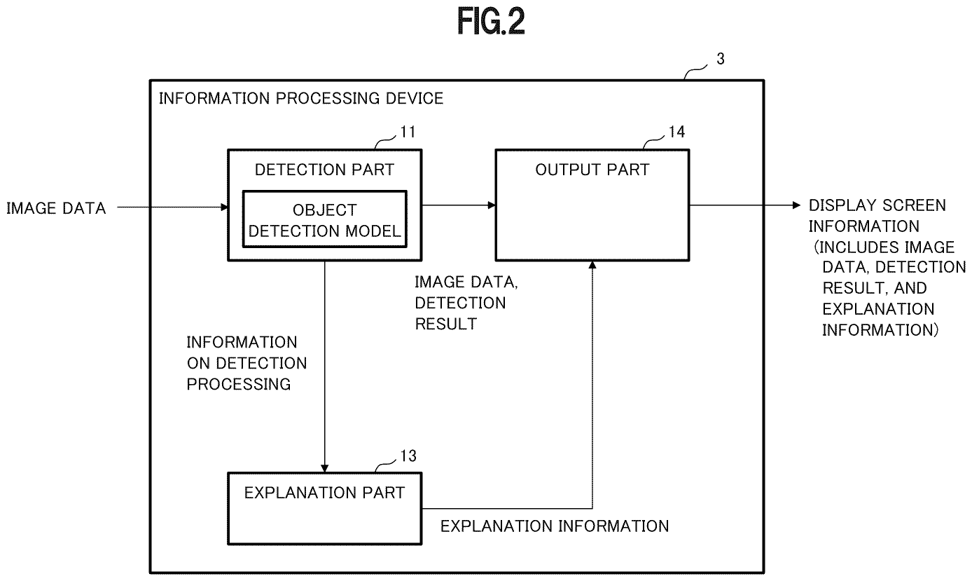

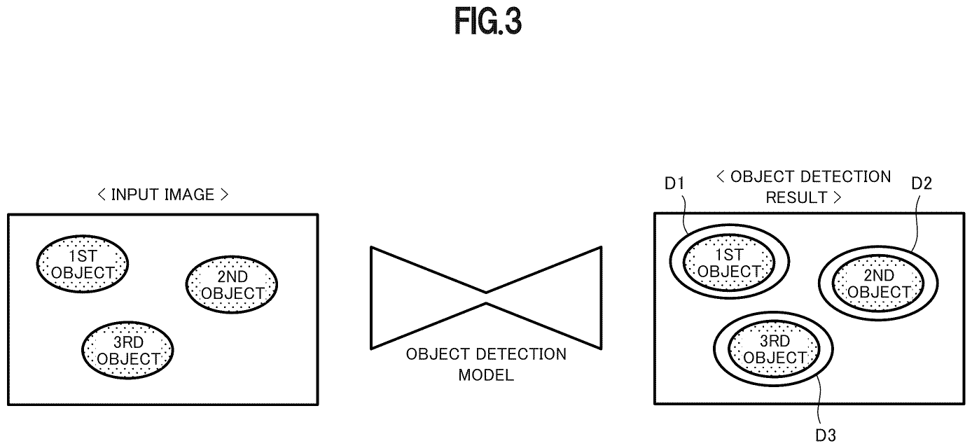

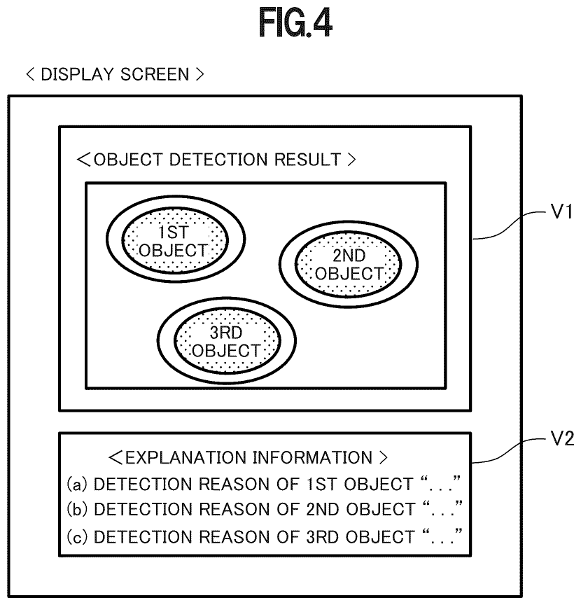

A configuration of the information processing device 3 and content of processing performed by the information processing device 3 will be described with reference to FIGS. 2 to 4 (see FIG. 1 as appropriate). FIG. 2 is an example of the configuration of the information processing device 3. FIG. 3 is an image of processing by an object detection model. FIG. 4 is an example of an output of the information processing device 3.

As illustrated in FIG. 2, the information processing device 3 includes a detection part 11, an explanation part 13, and an output part 14. The detection part 11, the explanation part 13, and the output part 14 are implemented by, for example, executing a program.

The detection part 11 includes an object detection model. Image data captured by the imaging device 2 is input to the detection part 11. The object detection model is a detector that has learned to detect a target (here, an object) when image data is input. The object detection model may, for example, be a convolutional neural network (CNN) and may use a technique such as You Only Look Once (YOLO) or Single Shot MultiBox Detector (SSD). A method of training the object detection model is not particularly limited. The object detection model is an example of a “first trained model”.

As illustrated in FIG. 3, the object detection model detects an area (target area) of an object that is a target of detection in an image, and outputs information on the target area as a detection result (the information on the target area may be information on a frame surrounding the detected area, or the like). In FIG. 3, three objects (a first object, a second object, and a third object) appear in the input image. The object detection model detects a target area D1 corresponding to the first object, a target area D2 corresponding to the second object, and a target area D3 corresponding to the third object.

As illustrated in FIG. 2, the detection part 11 outputs the image data used for detection and the detection result to the output part 14. In addition, the detection part 11 outputs information on a detection processing to the explanation part 13.

The explanation part 13 illustrated in FIG. 2 obtains, for each target area (each detection target), a reason why the detection part 11 has detected the target area using the XAI method. Further, the explanation part 13 outputs the reason of detection to the output part 14 as explanation information in association with the target area. The method of XAI used by the explanation part 13 is not particularly limited and may use, for example, a method such as a class activation map (CAM), SHapley Additive explanations (SHAP), or similar image retrieval. Information on the detection processing is input from the detection part 11 to the explanation part 13. The information on the detection processing broadly includes (1) information on the object detection model used in the detection processing; (2) information generated in the course of the detection processing; (3) information output as a result of the detection processing; (4) information obtained by processing these pieces of information, or the like. Information to be input to the explanation part 13 is preferably determined based on the XAI method used in the explanation part 13.

For example, the explanation part 13 applies the XAI method to information on the target area D1 illustrated in FIG. 3, and obtains a detection reason of the first object (target area D1). Further, the explanation part 13 applies the XAI method to information on the target area D2 illustrated in FIG. 3, and obtains a detection reason of the second object (target area D2). Further, the explanation part 13 applies the XAI method to information on the target area D3 illustrated in FIG. 3, and obtains a detection reason of the third object (target area D3). Then, the explanation part 13 outputs the detection reason of the first object (target area D1), the detection reason of the second object (target area D2), and the detection reason of the third object (target area D3) to the output part 14 as the explanation information.

The output part 14 illustrated in FIG. 2 creates information (display screen information) to be displayed on the display 4 (see FIG. 1). As illustrated in FIG. 2, the image data and the detection result are input to the output part 14 from the detection part 11, and the explanation information is input to the output part 14 from the explanation part 13. The output part 14 creates display screen information in which the detection result of the object is reflected in the image data and the reason for detecting the detection target is associated with the detection result. The output part 14 outputs the generated display screen information to the display 4. An example of a display screen by the display 4 is illustrated in FIG. 4. The display screen shown in FIG. 4 includes an area V1 for displaying the image data reflecting the detection result and an area V2 for displaying the explanation information.

The information processing device 3 according to the first embodiment of the present invention configured as described above has the following effect.

That is, the information processing device 3 according to the present embodiment includes a detection part 11 and an explanation part 13. The explanation part 13 uses an XAI method to obtain, for each target area (each detection target), a reason why the detection part 11 has detected the target area. Therefore, even in a case where there are a plurality of detection areas in the image, it is possible to correctly provide an explanation of the detection result.

### Second Embodiment

In a second embodiment, a model for a target area (second trained model) for inputting a target area detected by the object detection model (first trained model) is separately prepared, and an XAI method is applied to the model for a target area. The difference from the first embodiment is the configuration of the information processing device 3, and the difference will be mainly described below.

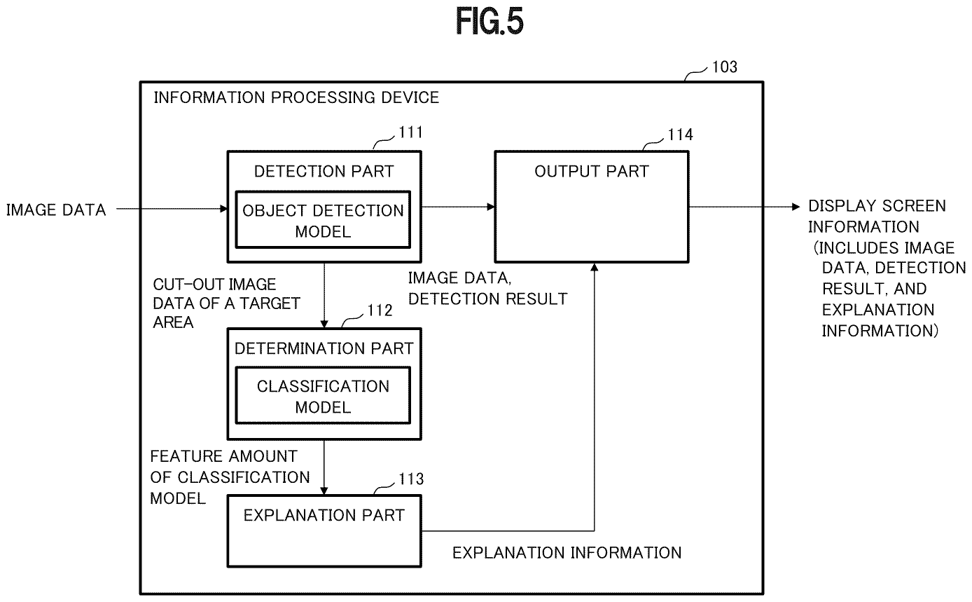

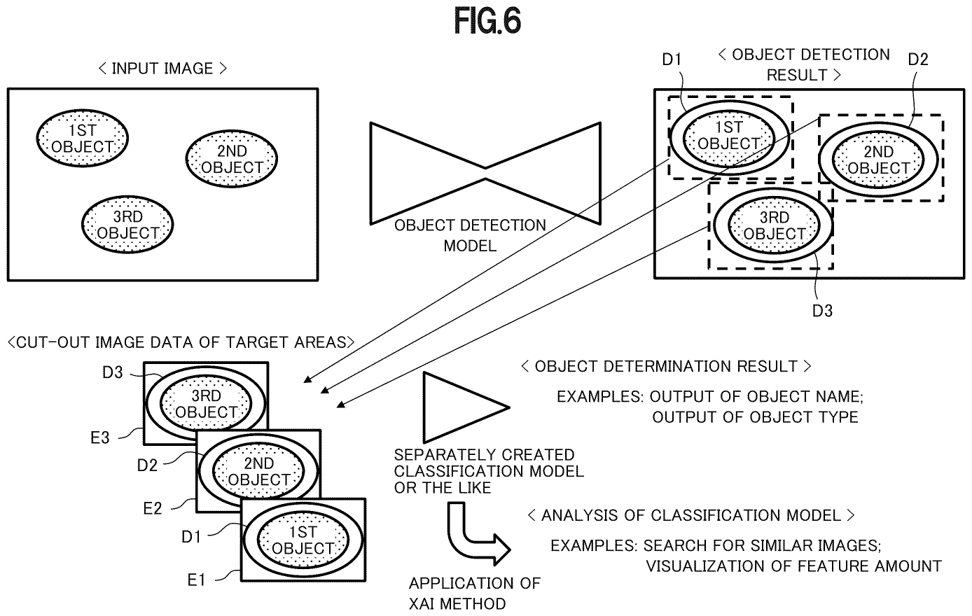

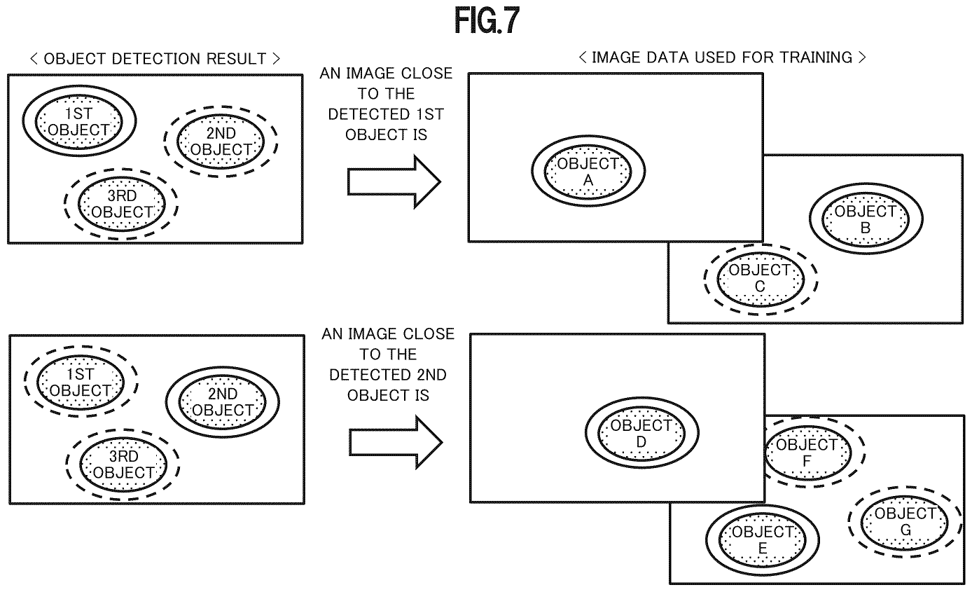

A configuration of an information processing device 103 according to the second embodiment and content of processing performed by the information processing device 103 will be described with reference to FIG. 5 to FIG. 7 (see FIG. 1 to FIG. 4 as appropriate). FIG. 5 is an example of the configuration of the information processing device 103. FIG. 6 is an image of the processing by the information processing device 103. FIG. 7 is an image of processing by the explanation part 113 of the second embodiment.

As illustrated in FIG. 5, the information processing device 103 includes a detection part 111, a determination part 112, an explanation part 113, and an output part 114. The detection part 111, the determination part 112, the explanation part 113, and the output part 114 are implemented, for example, by executing a program.

The detection part 111 illustrated in FIG. 5 includes an object detection model (a first trained model), and receives input of image data captured by the imaging device 2. The object detection model is a detector that has learned to detect a target (here, an object) when image data is input. A type and configuration of the object detection model and a method of training the object detection model are not particularly limited. The object detection model detects an area (target area) of an object that is a target of detection in an image, and outputs information on the target area (which may be information on a frame surrounding the detected area) as a detection result.

As illustrated in FIG. 5, the detection part 111 outputs the image data used for detection and the detection result to the output part 114. Further, the detection part 111 outputs image data obtained by cutting out the target area to the determination part 112.

FIG. 6 illustrates a case where the object detection model detects a target area D1 corresponding to a first object, a target area D2 corresponding to a second object, and a target area D3 corresponding to a third object. In this case, the detection part 111 outputs, to the determination part 112, cut-out image data E1 of the target area D1, cut-out image data E2 of the target area D2, and cut-out image data E3 of the target area D3.

The determination part 112 illustrated in FIG. 5 includes a model for a target area (a second trained model), and cut-out image data of the target area is input to the model. In the present embodiment, a classification model is assumed as the second trained model. The classification model is a detector that has learned to classify a target (here, an object) appearing in an image when image data is input. The classification model may, for example, be a convolutional neural network (CNN) and may use a technique such as EfficientNet or Residual Network (ResNet). A method of training the classification model is not particularly limited.

As shown in FIG. 6, the classification model determines a target (here, an object) appearing in a cut-out image of a target area, and outputs an object determination result. The object determination result is, for example, an object name or an object type. For example, the cut-out image data E1 of the target area D1 is input to the classification model, and the classification model outputs a type of the first object. Further, the cut-out image data E2 of the target area D2 is input to the classification model, and the classification model outputs a type of the second object. Further, cut-out image data E3 of the target area D3 is input to the classification model, and the classification model outputs a type of the third object.

A case where an abnormality is detected as a detection target will be described. The abnormality to be detected as the detection target is, for example, unevenness, a flaw, or the like. In this case, the target area is an abnormality candidate, and the abnormality candidate is input to the classification model. Then, the classification model outputs a type of unevenness or a type of a flaw.

As illustrated in FIG. 5, the determination part 112 outputs a feature amount of the classification model after determining the target to the explanation part 113. The determination part 112 acquires the feature amount of the classification model for each target, and outputs the feature amount of the classification model to the explanation part 113 in association with the classified target. For example, as illustrated in FIG. 6, the determination part 112 acquires a feature amount of the classification model obtained by classifying the cut-out image data E1 of the target area D1, and outputs the feature amount to the explanation part 113 in association with the first object. Further, the determination part 112 acquires a feature amount of the classification model obtained by classifying the cut-out image data E2 of the target area D2, and outputs the feature amount to the explanation part 113 in association with the second object. In addition, the determination part 112 acquires a feature amount of the classification model obtained by classifying the cut-out image data E3 of the target area D3, and outputs the feature amount to the explanation part 113 in association with the third object.

The explanation part 113 applies an XAI method to the feature amount of the model for a target area (here, the classification model) and obtains, for each target area (each detection target), a reason why the detection part 111 has detected the target area. Next, the explanation part 113 outputs the reason for detection to the output part 114 as explanation information in association with the target area. The method of XAI used by the explanation part 113 is not particularly limited, and may use, for example, a method such as Class Activation Map (CAM), SHapley Additive exPlanations (SHAP), or similar image retrieval.

For example, the explanation part 113 applies the XAI method to the feature amount of the classification model obtained by classifying the cut-out image data E1 of the target area D1, and obtains a detection reason of the first object (target area D1). Further, the explanation part 113 applies the XAI method to the feature amount of the classification model obtained by classifying the cut-out image data E2 of the target area D2, and obtains a detection reason of the second object (target area D2). In addition, the explanation part 113 applies the XAI method to the feature amount of the classification model obtained by classifying the cut-out image data E3 of the target area D3, and obtains a detection reason of the third object (target area D3). Then, the explanation part 113 outputs the detection reason of the first object (target area D1), the detection reason of the second object (target area D2), and the detection reason of the third object (target area D3) to the output part 114 as the explanation information.

With reference to FIG. 7, a case where the explanation part 113 uses a similar image retrieval method as XAI will be described as an example. The explanation part 113 searches for and retrieves an image in which an object close to a detected target appears from image data used for training. For example, the explanation part 113 searches the image data by comparing feature amounts, and acquires an image in which an object A appears or an image in which an object B appears as an image that is close to the detected first object. Further, the explanation part 113 acquires an image in which an object D appears or an image in which an object E appears as an image that is close to the detected second object. Although not illustrated, the explanation part 113 acquires an image that is close to the detected third object by a similar method. The explanation part 113 outputs the searched for and retrieved similar image or information based on the similar image (e.g., an explanation that may be obtained from the similar image) to the output part 114.

The output part 114 illustrated in FIG. 5 creates information (display screen information) to be displayed on the display 4 (see FIG. 1). As shown in FIG. 5, the image data and the detection result are input from the detection part 111 to the output part 114, and the explanation information is input from the explanation part 113 to the output part 114. The output part 114 creates display screen information in which the detection result of the object is reflected in the image data and the reason for detecting the detection target is associated with the detection result. For example, the output part 114 creates display screen information that includes image data reflecting the detection result and an image close to the detected target. The output part 114 outputs the generated display screen information to the display 4.

The information processing device 103 according to the second embodiment of the present invention configured as described above has the following effect.

The information processing device 103 according to the present embodiment achieves the same effect as the information processing device 3 according to the first embodiment. Specifically, the information processing device 103 according to the present embodiment includes a detection part 111, a determination part 112, and an explanation part 113. The determination part 112 acquires a feature amount of a model for a target area (here, a classification model). The explanation part 113 applies an XAI method to the feature amount of the model and obtains, for each target area (each detection target), a reason why the detection part 111 has detected the target area. Therefore, even in a case where there are a plurality of detection areas in the image, it is possible to correctly provide an explanation of the detection result.

### Third Embodiment

In the third embodiment, an XAI method is applied to a masked feature map obtained by performing mask processing on a feature map of an object detection model (first trained model). The difference from the first embodiment is the configuration of the information processing device 3, and the difference will be mainly described below.

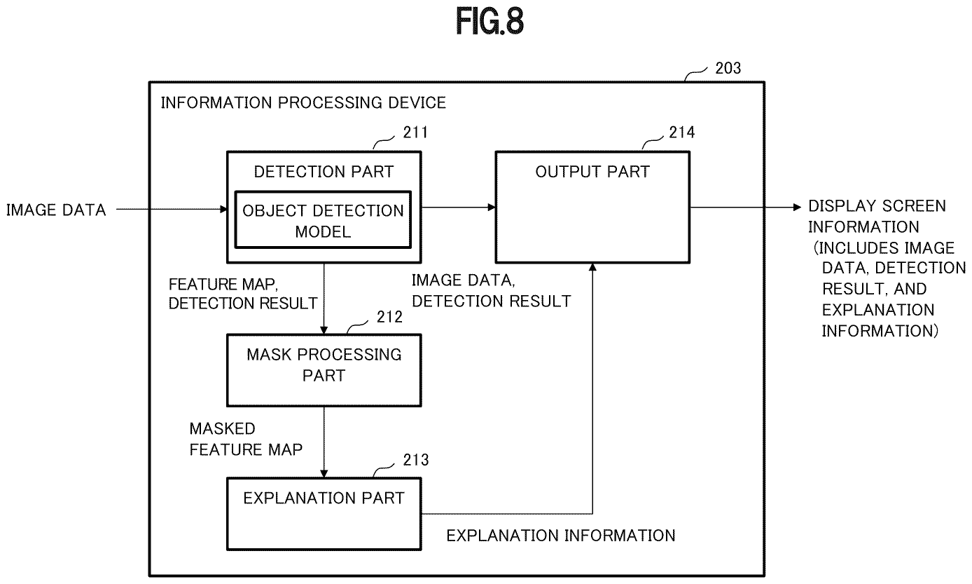

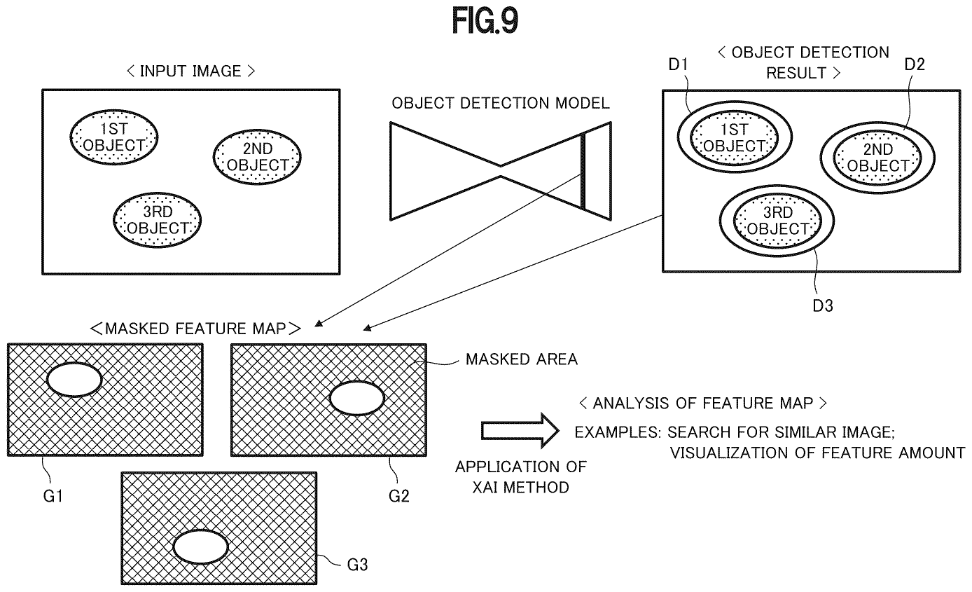

A configuration of an information processing device 203 according to the third embodiment and content of processing performed by the information processing device 203 will be described with reference to FIG. 8 and FIG. 9 (see FIG. 1 to FIG. 7 as appropriate). FIG. 8 is an example of a configuration of the information processing device 203. FIG. 9 is an image of processing by the information processing device 203.

As illustrated in FIG. 8, the information processing device 203 includes a detection part 211, a mask processing part 212, an explanation part 213, and an output part 214. The detection part 211, the mask processing part 212, the explanation part 213, and the output part 214 are implemented by, for example, executing a program.

The detection part 211 illustrated in FIG. 8 includes an object detection model (first trained model), and image data captured by the imaging device 2 is input thereto. The object detection model is a detector that has learned to detect a target (here, an object) when image data is input. A type and configuration of the object detection model and a method of training the object detection model are not particularly limited. The object detection model detects an area (a target area) of an object that is a target of detection in an image, and outputs information on the target area (which may be information on a frame surrounding the detected area) as a detection result.

As illustrated in FIG. 8, the detection part 211 outputs the image data used for detection and the detection result to the output part 214. Further, the detection part 211 outputs a feature map of the object detection model and the detection result to the mask processing part 212.

FIG. 9 illustrates a case where the object detection model detects a target area D1 corresponding to a first object, a target area D2 corresponding to a second object, and a target area D3 corresponding to a third object. In this case, the detection part 211 outputs information on the target area D1, information on the target area D2, and information on the target area D3 to the mask processing part 212 as the detection result.

The feature map of the object detection model and the detection result are input to the mask processing part 212 illustrated in FIG. 8. The mask processing part 212 masks the feature map using the detection result, and outputs the masked feature map to the explanation part 213. The mask processing part 212 creates, for each detection target, a masked feature map in which an area other than an area corresponding to the target area is set as a masked area, and outputs the masked feature map to the explanation part 213 in association with the detection target. The mask processing part 212 masks the feature map using, for example, binarization processing or contour extraction processing. The mask processing may be performed based on an area of interest of the feature map.

For example, as shown in FIG. 9, the mask processing part 212 creates a masked feature map G1 in which an area other than the area corresponding to the target area D1 is set as a masked area, and outputs the masked feature map G1 to the explanation part 213 in association with the first object. Furthermore, the mask processing part 212 creates a masked feature map G2 in which an area other than the area corresponding to the target area D2 is set as a masked area, and outputs the masked feature map G2 to the explanation part 213 in association with the second object. Further, the mask processing part 212 creates a masked feature map G3 in which an area other than the area corresponding to the target area D3 is set as a masked area, and outputs the masked feature map G3 to the explanation part 213 in association with the third object.

The explanation part 213 illustrated in FIG. 8 applies an XAI method to the masked feature map obtained by masking the feature map of the object detection model (first trained model), and obtains, for each target area (each detection target), a reason why the detection part 211 has detected the target area. Then, the explanation part 213 outputs the reason for detection to the output part 214 as explanation information in association with the target area. The method of XAI used by the explanation part 213 is not particularly limited, and may use, for example, a method such as Class Activation Map (CAM), SHapley Additive explanations (SHAP), or similar image retrieval. When the explanation part 213 uses a method of similar image retrieval as the XAI, for example, image data used for training is searched to retrieve an image close to the detected target by the same processing used in the second embodiment (see FIG. 7).

For example, the explanation part 213 applies the XAI method to the masked feature map G1 in which an area other than the area corresponding to the target area D1 is set as the masked area, and obtains a detection reason of the first object (target area D1). In addition, the explanation part 213 applies the XAI method to the masked feature map G2 in which an area other than the area corresponding to the target area D2 is set as the masked area, and obtains a detection reason of the second object (target area D2). In addition, the explanation part 213 applies the XAI method to the masked feature map G3 in which an area other than the area corresponding to the target area D3 is set as the masked area, and obtains a detection reason of the third object (target area D3). Then, the explanation part 213 outputs the detection reason of the first object (target area D1), the detection reason of the second object (target area D2), and the detection reason of the third object (target area D3) to the output part 214 as the explanation information. Processing of the output part 214 is the same as that of the output part 114 (see FIG. 5) of the second embodiment.

The information processing device 203 according to the third embodiment of the present invention configured as described above has the following effect.

The information processing device 203 according to the present embodiment achieves the same effect as the information processing device 3 according to the first embodiment. Specifically, the information processing device 203 according to the present embodiment includes a detection part 211, a mask processing part 212, and an explanation part 213. The mask processing part 212 creates a masked feature map obtained by masking a feature map of an object detection model. The explanation part 213 applies an XAI method to the masked feature map, and obtains, for each target area (each detection target), a reason why the detection part 211 has detected the target area. Therefore, even in a case where there are a plurality of detection areas in an image, it is possible to correctly provide an explanation of the detection result.

Although embodiments of the present invention have been described above, the present invention is not limited to the above-described embodiments. The present invention may be implemented with appropriate modifications.

### REFERENCE SIGNS LIST

1 Information processing system
2 Imaging device
3, 103, 203 Information processing device
4 Display
5 Input device
10 Processor
11, 111, 211 Detection part
112 Determination part
212 Mask processing part
13, 113, 213 Explanation part
14, 114, 214 Output part
20 Non-transitory storage medium
D1, D2, D3 Target area
E1, E2, E3 Cut-out image data
G1, G2, G3 Masked feature map

1. An information processing device, comprising:
a hardware processor configured to:
detect, as a detection part, a plurality of target areas from one image by using a first trained model, and
output, as an explanation part, explanation information explaining a reason for detection for each of the plurality of target areas detected by the detection part.

2. The information processing device according to claim 1, wherein the hardware processor is configured to apply, as the explanation part, a method of explainable AI to information on detection processing of the detection part to obtain the explanation information of each of the plurality of target areas.

3. The information processing device according to claim 1, wherein the hardware processor is configured to:
perform, as a determination part, processing of classifying a detection target using a second trained model,
acquire, as the determination part, a feature amount of the second trained model after the processing,
acquire, as the determination part, a feature amount of each target area by inputting a cut-out image of the target area to the second trained model, and
apply, as the explanation part, is a method of explainable AI to the feature amount of each target area acquired from the second trained model to obtain the explanation information of each of the plurality of target areas.

4. The information processing device according to claim 1, wherein the hardware processor is configured to:
perform, as a mask processing part, mask processing on a feature map of the first trained model,
generate, as the mask processing part, a masked feature map of each of the target areas by performing mask processing using each of the target areas, and
apply, as the explanation part, a method of explainable AI to the masked feature map of each of the target areas to obtain the explanation information of each of the plurality of target areas.

5. The information processing device according to claim 1, wherein
each of the plurality of target areas is an abnormality candidate, and
the hardware processor is configured to output, as the explanation part, explanation information explaining a reason for detection for each of the plurality of abnormality candidates.

6. The information processing device according to claim 1, wherein the hardware processor is configured to:
search for and retrieve, as the explanation part, a similar image that is similar to a detection target from among training images by using a method of similar image retrieval, and
output, as the explanation information, for each of the plurality of target areas, the similar image that has been retrieved or information based on the similar image.

7. (canceled)

8. A non-transitory storage medium storing a computer-readable program causing a computer to perform:
detecting, with a hardware processor, a plurality of target areas from one image using a first trained model; and
outputting, with the hardware processor, explanation information explaining a reason for detection for each of the plurality of target areas detected by the hardware processor.

9. An information processing system, comprising:
an imaging device configured to capture an image of a detection target;
an information processing device configured to perform object detection processing on the image captured by the imaging device; and
a display configured to display a result of detection by the information processing device, wherein
the information processing device comprises a hardware processor configured to:
detect, as a detection part, a plurality of target areas from one image by using a first trained model,
output, as an explanation part, explanation information explaining a reason for detection for each of the plurality of target areas detected by the detection part, and
output, as an output part, display screen information in which the target areas are reflected in the image and the explanation information is associated with the respective target areas.
